(19) United States
(12) Patent Application Publication
(10) Pub. No.: US 2026/0079511 A1
(43) Pub. Date: Mar. 19, 2026

(54) FIELD EQUIPMENT FRAMEWORK

(71) Applicant: Schlumberger Technology Corporation, Sugar Land, TX (US)

(72) Inventors: Indranil Roychoudhury, Menlo Park (TX); Naveen Gupta, Menlo Park, CA (US); Priya Mishra, Menlo Park, CA (US); Hui Wang, Menlo Park, CA (US); Salma Benslimane, Menlo Park, CA (US); Jose R. Celaya Galvan, Menlo Park, CA (US)

(21) Appl. No.: 19/322,169

(22) Filed: Sep. 8, 2025

Related U.S. Application Data
(60) Provisional application No. 63/694,416, filed on Sep. 13, 2024.

(51) Int. Cl. G05D 27/02; E21B 41/00

(52) U.S. Cl. CPC G05D 27/02; E21B 41/00

(57) ABSTRACT

A method can include receiving sensor data from one or more sensors in a field system that includes field equipment; generating latent space representations of the sensor data utilizing a time series foundation model; and, based at least in part on a portion of the latent space representations, characterizing operation of one or more pieces of the field equipment.

### RELATED APPLICATION(S)

This application claims priority to and the benefit of a U.S. Provisional Application having Ser. No. 63/694,416, filed 13 Sep. 2024, which is incorporated by reference herein in its entirety.

### BACKGROUND

Field equipment may be deployed in a field to perform various operations. During such operations, field equipment may experience one or more types of issues that may impact the operations, whether past, present and/or future. As an example, consider field equipment that may perform operations with respect to a reservoir, which may be a subsurface formation that may be part of a basin such as a sedimentary basin. A reservoir may include hydrocarbon fluids (e.g., oil, gas, etc.) and/or non-hydrocarbon fluids (e.g., water). Field equipment may be utilized to perform operations with respect to a reservoir, such as, for example, drilling, fracturing, completing, fluid injecting, fluid producing, fluid processing, etc. Characteristics of field equipment may be challenging to ascertain, manage, and control, particularly where field equipment may be deployed remote from urban infrastructure. A field equipment framework may provide for improved characterization of field equipment and improved field operations.

### SUMMARY

A method can include receiving sensor data from one or more sensors in a field system that includes field equipment; generating latent space representations of the sensor data utilizing a time series foundation model; and, based at least in part on a portion of the latent space representations, characterizing operation of one or more pieces of the field equipment. A system can include a processor; a memory accessible to the processor; processor-executable instructions stored in the memory and executable by the processor to instruct the system to: receive sensor data from one or more sensors in a field system that includes field equipment; generate latent space representations of the sensor data utilizing a time series foundation model; and, based at least in part on a portion of the latent space representations, characterize operation of one or more pieces of the field equipment. One or more computer-readable media may include computer-executable instructions executable by a system to instruct the system to: receive sensor data from one or more sensors in a field system that includes field equipment; generate latent space representations of the sensor data utilizing a time series foundation model; and, based at least in part on a portion of the latent space representations, characterize operation of one or more pieces of the field equipment. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of systems;

FIG. 3 illustrates an example of a system;

FIG. 4 illustrates an example of a system;

FIG. 5 illustrates an example of a system;

FIG. 6 illustrates an example of a graphical user interface;

FIG. 7 illustrates an example of a graphical user interface;

FIG. 8 illustrates an example of a graphical user interface;

FIG. 9 illustrates an example of a graphical user interface;

FIG. 10 illustrates an example of a system;

FIG. 11 illustrates example graphics of techniques;

FIG. 12 illustrates an example of a system;

FIG. 13 illustrates an example of a method and an example of a system;

and

FIG. 14 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

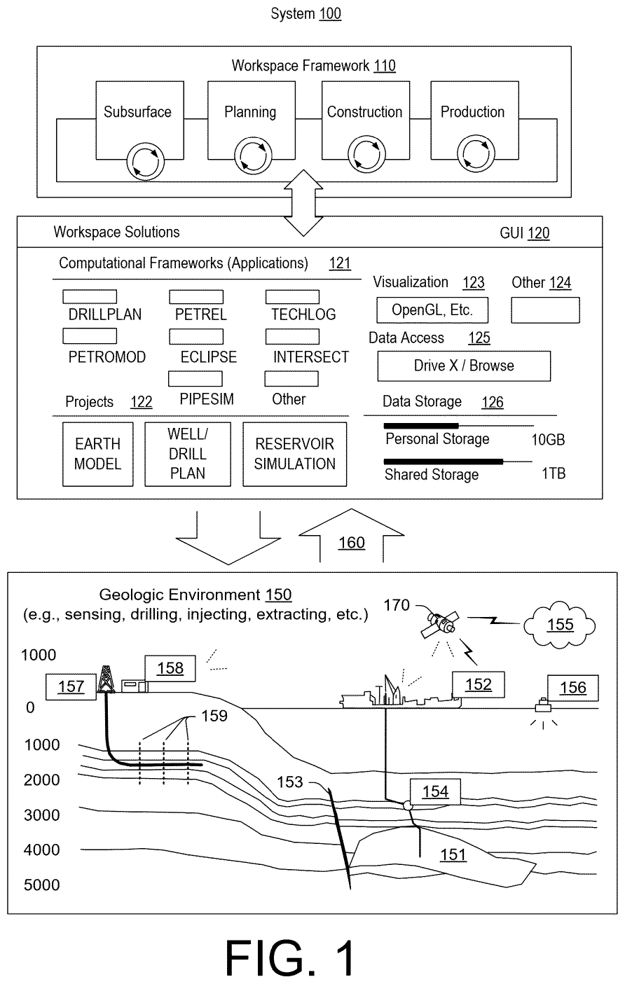

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite 170 may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, PIPESIM, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive E&P environment (SLB, Houston, Texas) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages. Examples of such software packages include the PETREL framework. As an example, a system or systems may utilize a framework such as the DELFI framework (SLB, Houston, Texas). Such a framework may operatively couple various other frameworks to provide for a multi-framework workspace. As an example, the GUI 120 of FIG. 1 may be a GUI of the DELFI framework.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such an approach can provide for compatibility of devices, frameworks, etc., with respect to one or more sets of instructions.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data.

A simulator can be utilized to simulate the exploitation of a real reservoir, for example, to examine different productions scenarios to find an optimal one before production or further production occurs. A reservoir simulator does not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results too are to some extent uncertain. A process known as history matching can involve comparing simulation results to actual field data acquired during production of fluid from a field. Information gleaned from history matching, can provide for adjustments to a model, data, etc., which can help to increase accuracy of simulation.

While several simulators are illustrated in the example of FIG. 1, one or more other simulators may be utilized, additionally or alternatively. For example, consider the PIPESIM network simulator (SLB, Houston Texas), etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

As an example, the SYMMETRY framework (SLB, Houston, Texas) may be utilized, which includes process simulation features that can model process workflows, integrating facilities, process units with pipelines, networks and flare, safety systems models, while ensuring thermodynamic and fluid characterization across a system. Such a framework may be operatively coupled with one or more other frameworks. As an example, a workflow may aim to optimize processes in upstream, midstream and/or downstream sectors, which, may, for example, aim to maximize efficiency and minimize CAPEX.

The PETREL framework provides components that allow for optimization of exploration and development operations. The PETREL framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes (e.g., with respect to one or more geologic environments, etc.). Such a framework may be considered an application (e.g., executable using one or more devices) and may be considered a data-driven application (e.g., where data is input for purposes of modeling, simulating, etc.).

As mentioned, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

As an example, a platform, such as, for example, the LUMI platform (SLB, Houston, Texas) may be utilized. The LUMI platform includes features that provide for artificial intelligence solutions as may be integrated with data management capabilities. The LUMI platform provides for flexible deployment options and an open, secure, and modular architecture, for example, to empower data-driven decision-making. The LUMI platform is operable with the DELFI environment and, hence, one or more of various frameworks. While various platforms, environments, frameworks, libraries, etc., are mentioned, a framework may be operable in an agnostic manner, for example, to be compatible with one or more other platforms, environments, frameworks, libraries, technologies, etc.

As an example, a workflow may utilize one or more types of data for one or more processes (e.g., stratigraphic modeling, basin modeling, completion designs, drilling, production, injection, etc.). As an example, one or more tools may provide data that can be used in a workflow or workflows that may implement one or more frameworks (e.g., PETREL, TECHLOG, PETROMOD, ECLIPSE, SYMMETRY, etc.).

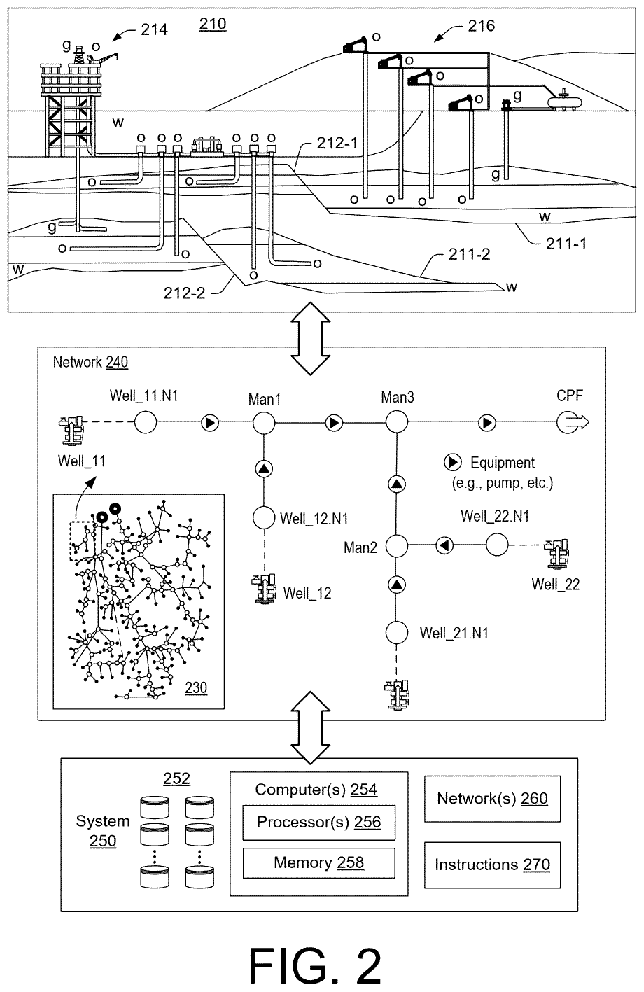

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1. In the example network 240, various types of equipment may be included, which may include equipment for fluid handling, fluid processing, etc. As an example, one or more types of pumps may be included, where a pump may be a compressor. As an example, one or more types of separators may be included, one or more types of heat exchangers may be included, etc.

As explained, various equipment may be provided to perform one or more functions, which may be for fluid handling, fluid processing, etc., noting that flaring equipment may be present. As an example, operations may involve leakage of gas, combustion of gas, compression of gas, etc., where gas may be a greenhouse gas (GHG), which may be relevant to one or more types of emissions (e.g., methane, CO2, etc.). As an example, operations may involve production and/or sequestration operations. For example, consider sequestration of CO2 where CO2 is injected into a reservoir using equipment in a network. Hence, while production is mentioned, one or more techniques, technologies, etc., may be utilized for purposes of injection, additionally or alternatively.

In the example of FIG. 2, the various equipment 214 and 216 can include drilling equipment, wireline equipment, production equipment, etc. For example, consider the equipment 214 as including a drilling rig that can drill into a formation to reach a reservoir target where a well can be completed for production of hydrocarbons. In such an example, one or more features of the system 100 of FIG. 1 may be utilized. For example, consider utilizing the DRILLPLAN framework to plan, execute, etc., one or more drilling operations. As another example, consider the SYMMETRY framework for planning, monitoring, controlling, etc., production operations.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil (o) and gas (g) fluids from well locations along flowlines interconnected at junctions with final delivery at a central processing facility.

In the example of FIG. 2, various portions of the network 240 may include conduit. For example, consider a perspective view of a geologic environment that includes two conduits which may be a conduit to a manifold Man1 and a conduit to Man3 in the network 240. A multiphase flowmeter (MPFM) may be installed at the flowline of each well (Well_11, Well_12, Well_22, etc.) to provide continuous production data of each well, for example, consider one or more of a gas flow rate, an oil flow rate and a water flowrate, for production allocation, production management, or for improved reservoir modeling (e.g., production history matching, forecasting).

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, well production data etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.). As an example, one or more methods, techniques, etc. may be performed using one or more sets of instructions, which may be, for example, the instructions 270 of FIG. 2.

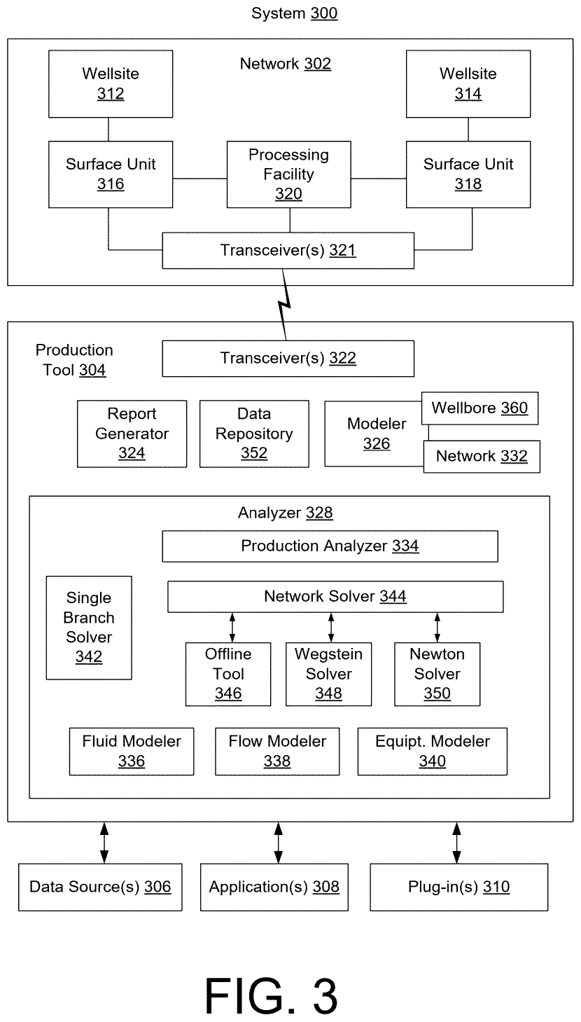

FIG. 3 shows an example of a schematic diagram of a production system 300 for performing oilfield production operations. As shown in the example of FIG. 3, the production system 300 can include an oilfield network 302, an oilfield production tool 304, one or more data sources 306, one or more oilfield application(s) 308, and one or more plug-in(s) 310. As an example, the oilfield network 302 can be an interconnection of pipes (e.g., conduits) that connects wellsites (e.g., a wellsite 1 312, a wellsite n 314, etc.) to a processing facility 320. A pipe in the oilfield network 302 may be connected to a processing facility (e.g., a processing facility 320), a wellsite (e.g., the wellsite 1 312, the wellsite n 314, etc.), and/or a junction in which pipes are connected. As an example, flow rate of fluid and/or gas into pipes may be adjustable; thus, certain pipes in the oilfield network 302 may be choked or closed so as to not allow fluid and/or gas through the pipe. A pipe may be considered open (e.g., optionally choked) when the pipe allows for flow of fluid and/or gas. As to a choke, choking may allow for adjusting one or more characteristics of a piece of flow equipment (e.g., a cross-sectional flow area, etc.), for example, for adjusting to fully open flow, for adjusting to choked flow and/or for adjusting to no flow (e.g., closed).

As an example, a choke may include an orifice that is used to control fluid flow rate or downstream system pressure. As an example, a choke may be provided in any of a variety of configurations (e.g., for fixed and/or adjustable modes of operation). As an example, an adjustable choke may enable fluid flow and pressure parameters to be changed to suit process or production requirements. As an example, a fixed choke may be configured for resistance to erosion under prolonged operation or production of abrasive fluids.

The oilfield network 302 may be a gathering network and/or an injection network. A gathering network may be an oilfield network used to obtain hydrocarbons from a wellsite (e.g., the wellsite 1 312, the wellsite n 314, etc.). In a gathering network, hydrocarbons may flow from the wellsites to the processing facility 320. An injection network may be an oilfield network used to inject the wellsites with injection substances, such as water, carbon dioxide, and other chemicals that may be injected into the wellsites. In an injection network, the flow of the injection substance may flow towards the wellsite (e.g., toward the wellsite 1 312, the wellsite n 314, etc.).

The oilfield network 302 may also include one or more surface units (e.g., a surface unit 1 316, a surface unit n 318, etc.), for example, a surface unit for each wellsite. Such surface units may include functionality to collect data from sensors (see, e.g., equipment of FIG. 1, FIG. 2, etc.). Such sensors may include sensors for measuring flow rate, water cut, gas lift rate, pressure, and/or other such variables related to measuring and monitoring hydrocarbon production. As shown, the oilfield network 302 can include one or more transceivers 321, for example, to receive information, to transmit information, to receive information and transmit information, etc. As an example, information may be received and/or transmitted via wire and/or wirelessly. As an example, information may be received and/or transmitted via a communications network such as, for example, the Internet, the Cloud, a cellular network, a satellite network, etc.

As an example, the oilfield production tool 304 may be connected to the oilfield network 302. The oilfield production tool 304 may be a simulator (e.g., a simulation framework) or a plug-in for a simulator (e.g., or other application(s)). The oilfield production tool 304 may include one or more transceivers 322, a report generator 324, an oilfield modeler 326, and an oilfield analyzer 328. As an example, the one or more transceivers 322 may be configured to receive information, to transmit information, to receive information and transmit information, etc. As an example, information may be received and/or transmitted via wire and/or wirelessly. As an example, information may be received and/or transmitted via a communications network such as, for example, the Internet, the Cloud, a cellular network, a satellite network, etc.

As an example, one or more of the one or more transceivers 322 may include functionality to collect oilfield data. The oilfield data may be data from sensors, historical data, or any other such data. One or more of the one or more transceivers 322 may also include functionality to interact with a user and display data such as a production result.

As an example, the report generator 324 can include functionality to produce graphical and textual reports. Such reports may show historical oilfield data, production models, production results, sensor data, aggregated oilfield data, or any other such type of data.

As an example, the data repository 352 may be a storage unit and/or device (e.g., a file system, database, collection of tables, or any other storage mechanism) for storing data, such as the production results, sensor data, aggregated oilfield data, or any other such type of data. As an example, the data repository 352 may include multiple different storage units and/or hardware devices. Such multiple different storage units and/or devices may or may not be of the same type or located at the same physical site. As an example, the data repository 352, or a portion thereof, may be secured via one or more security protocols, whether physical, algorithmic or a combination thereof (e.g., data encryption, secure device access, secure communication, etc.).

In the example of FIG. 3, the oilfield modeler 326 can include functionality to create a model of a wellbore and an oilfield network. As shown, the oilfield modeler 326 includes a wellbore modeler 360 and a network modeler 332. As an example, the wellbore modeler 360 can allow a user to create a graphical wellbore model or single branch model. As an example, a wellbore model can define operating parameters (e.g., actual, theoretical, etc.) of a wellbore (e.g., pressure, flow rate, etc.). As an example, a single branch model may define operating parameters of a single branch in an oilfield network.

As to the network modeler 332, it may allow a user to create a graphical network model that combines wellbore models and/or single branch models. As an example, the network modeler 328 and/or wellbore modeler 360 may model pipes in the oilfield network 302 as branches of the oilfield network 302 (e.g., optionally as one or more segments, optionally with one or more nodes, etc.). In such an example, each branch may be connected to a wellsite or a junction. A junction may be defined as a group of two or more pipes that intersect at a particular location (e.g., a junction may be a node or a type of node).

As an example, a modeled oilfield network may be formed as a combination of sub-networks. In such an example, a sub-network may be defined as a portion of an oilfield network. For example, a sub-network may be connected to the oilfield network 302 using at least one branch. Sub-networks may be a group of connected wellsites, branches, and junctions. As an example, sub-networks may be disjoint (e.g., branches and wellsites in one sub-network may not exist in another sub-network).

As an example, the oilfield analyzer 328 can include functionality to analyze the oilfield network 302 and generate a production result for the oilfield network 302. As shown in the example of FIG. 3, the oilfield analyzer 328 may include one or more of the following: a production analyzer 334, a fluid modeler 336, a flow modeler 338, an equipment modeler 340, a single branch solver 342, a network solver 344, a Wegstein solver 348, a Newton solver 350, and an offline tool 346.

As an example, the production analyzer 334 can include functionality to receive a workflow request and interact with the single branch solver 342 and/or the network solver 344 based on particular aspects of the workflow. For example, the workflow may include a nodal analysis to analyze a wellsite or junction of branches, pressure and temperature profile, model calibration, gas lift design, gas lift optimization, network analysis, and other such workflows.

As an example, the fluid modeler 336 can include functionality to calculate fluid properties (e.g., phases present, densities, viscosities, etc.) using one or more compositional and/or black-oil fluid models. The fluid modeler 336 may include functionality to model oil, gas, water, hydrate, wax, and asphaltene phases. As an example, the flow modeler 338 can include functionality to calculate pressure drop in pipes (e.g., pipes, tubing, etc.) using industry standard multiphase flow correlations. As an example, the equipment modeler 340 can include functionality to calculate pressure changes in equipment pieces (e.g., chokes, pumps, compressors, etc.). As an example, one or more substances may be introduced via a network for purposes of managing asphaltenes, waxes, etc. As an example, a modeler may include functionality to model interaction between one or more substances and fluid (e.g., including material present in the fluid).

As an example, the single branch solver 342 may include functionality to calculate the flow and pressure drop in a wellbore or a single flowline branch given various inputs.

As an example, the network solver 344 can includes functionality calculate a flow rate and pressure drop throughout the oilfield network 302. The network solver 344 may be configured to connect to the offline tool 346, the Wegstein solver 348, and the Newton solver 350. As an example, alternatively or additionally, one or more other solvers may be provided, for example, consider a sequential linear programming solver (SLP), a sequential quadratic programming solver (SQP), etc. As an example, a solver may be part of the production tool 304, part of the analyzer 328 of the production tool 304, part of a system to which the production tool 304 may be operatively coupled, etc.

As an example, the offline tool 346 may include a wells offline tool and a branches offline tool. A wells offline tool may include functionality to generate a production model using the single branch solver 342 for a wellsite or branch. A branches offline tool may include functionality to generate a production model for a sub-network using the production model for a wellsite, a single branch, or a sub-network of the sub-network.

As an example, a production model may be capable of providing a description of a wellsite with respect to various operational conditions. A production model may include one or more production functions that may be combined, for example, where each production function may be a function of variables related to the production of hydrocarbons. For example, a production function may be a function of flow rate and/or pressure. Further, a production function may account for environmental conditions related to a sub-network of the oilfield network 302, such as changes in elevation (e.g., for gravity head, pressure, etc.), diameters of pipes, combination of pipes, and changes in pressure resulting from joining pipes. A production model may provide estimates of flow rate for a wellsite or sub-network of an oilfield network.

As an example, one or more separate production functions may exist that can account for changes in one or more values of an operational condition. An operational condition may identify a property of hydrocarbons or injection substance. For example, an operational condition may include a watercut (WC), reservoir pressure, gas lift rate, etc. Other operational conditions, variables, environmental conditions may be considered.

As to the network solver 344, in the example of FIG. 3, it is shown as being connected to the Wegstein solver 348 and/or the Newton solver 350. The Wegstein solver 348 and the Newton solver 350 include functionality to combine a production model for several sub-networks to create a production result that may be used to plan an oilfield network, optimize flow rates of wellsites in an oilfield network, and/or identify and address faulty components within an oilfield network. The Wegstein solver 348 can use an iterative method with Wegstein acceleration.

An oilfield network may be solved by identifying pressure drop (e.g., pressure differential), for example, through use of momentum equations. As an example, an equation for pressure differential may account for factors such as fluid potential energy (e.g., hydrostatic pressure), friction (e.g., shear stress between conduit wall and fluid), and acceleration (e.g., change in fluid velocity). As an example, an equation may be expressed in terms of static reservoir pressure, a flowing bottom hole pressure and flowrate. As an example, equations may account for vertical, horizontal or angled arrangements of equipment. Various examples of equations may be found in a dynamic multiphase flow simulator such as the simulator of the OLGA simulation framework (SLB, Houston, TX), which may be implemented for design and diagnostic analysis of oil and gas production systems. As an example, a simulation framework may include one or more sets of instructions for building a model; for fluid and multiphase flow modeling; for reservoir, well and completion modeling; for field equipment modeling; and for operations (e.g., artificial lift, gas lift, wax prediction, nodal analysis, network analysis, field planning, multi-well analysis, etc.).

In the example of FIG. 3, the one or more data sources 306 include one or more types of repositories for data. For example, the one or more data sources 306 may be Internet sources, sources from a company having ties to the oilfield network 302, or any other location in which data may be obtained. The data may include historical data, data collected from other oilfield networks, data collected from the oilfield network being modeled, data describing environmental or operational conditions.

In the example of FIG. 3, the one or more oilfield applications 308 may be applications related to the production of hydrocarbons. The one or more oilfield applications 308 may include functionality to evaluate a formation, manage drilling operations, evaluate seismic data, evaluate workflows in the oilfield, perform simulations, or perform any other oilfield related function. In the example of FIG. 3, the one or more plug-ins 310 may allow integration with packages such as, for example, a TUFPP model, an Infochem Multiflash model (Infochem Computer Services Ltd., London, UK), an equipment model, etc. (e.g., consider one or more simulators like HYSYS (AspenTech, Burlington, Massachusetts), UNISIM (Honeywell, Morristown, New Jersey), etc.).

While the example of FIG. 3 shows the oilfield production tool 304 as a separate component from the oilfield network 302, the oilfield production tool 304 may alternatively be part of the oilfield network 302. For example, the oilfield production tool 304 may be located at one of the wellsites (e.g., the wellsite 1 312, the wellsite n 314, etc.), at the processing facility 320, or any other location in the oilfield network 302. As another example, the oilfield production tool 304 may exist separate from the oilfield network 302, such as when the oilfield production tool 304 is used to plan the oilfield network.

As mentioned, a production system can provide for transportation of oil and gas fluids from well locations along flowlines which are interconnected at junctions to combine fluids from many wells for delivery to a processing facility. Along these flowlines (including at one or more ends of a flowline), production equipment may be inserted to modify the flowing characteristics like flow rate, pressure, composition and temperature. As an example, a boundary condition may depend on a type of equipment, operation of a piece of equipment, etc.

As an example, a simulation may be performed using one type of equipment along a flowline and another simulation may be performed using another type of equipment along the same flowline, for example, to determine which type of equipment may be selected for installation in a production system.

As an example, a simulation may be performed using one type of equipment at a position (e.g., with respect to a flowline) and another simulation may be performed using another type of equipment at a different position (e.g., with respect to the same flowline or a different flowline), for example, to determine which type of equipment may be selected for installation in a production system as well as to determine where a type of equipment may be installed. As an example, a simulation may be performed using one type of equipment at a position (e.g., with respect to a flowline) and another simulation may be performed using that type of equipment at a different position (e.g., with respect to the same flowline or a different flowline), for example, to determine where that type of equipment may be installed.

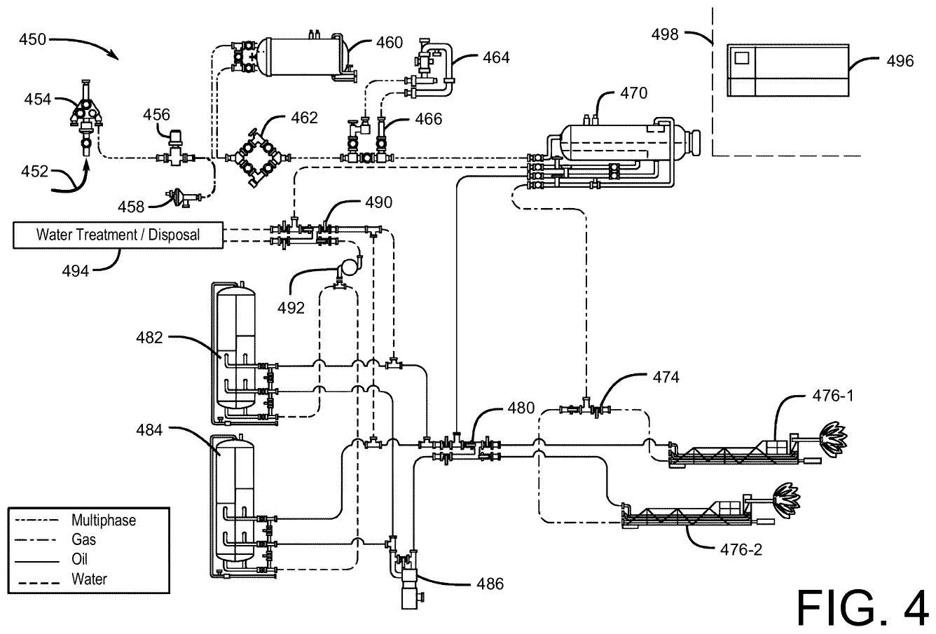

FIG. 4 shows an example of a system 450 that includes various types of equipment. As an example, one or more of the types of equipment may be present within a network such as, for example, the network of equipment 230 of FIG. 2, etc. In FIG. 4, a multiphase fluid (represented here by arrow 452) enters a flowhead 454 and is routed to a separator 470 through a surface safety valve 456, a steam-heat exchanger 460, a choke manifold 462, a flow meter 464, and an additional manifold 466. In the example of FIG. 4, the system 450 includes a chemical injection pump 458 for injecting chemicals into the multiphase fluid flowing toward the separator 470. As an example, one or more compressors may be included in a system at a well site and/or in a fluid production network, which may provide for fluid communication from one or more well sites to one or more facilities.

In the depicted embodiment of FIG. 4, the separator 470 is a three-phase separator that generally separates the multiphase fluid 452 into gas, oil, and water components. The separated gas is routed downstream from the separator 470 through a gas manifold 474 to either of the burners 476-1 and 476-2 for flaring gas and burning oil. The gas manifold 474 includes valves that can be actuated to control flow of gas from the gas manifold 474 to one or the other of the burners 476-1 and 476-2. Although shown next to one another in FIG. 4 for sake of clarity, the burners 476-1 and 476-2 may be positioned apart from one another, such as on opposite sides of a rig, etc.

As shown, the separated oil from the separator 470 can be routed downstream to an oil manifold 480. Valves of the oil manifold 480 can be operated to permit flow of the oil to either of the burners 476-1 and 476-2 or either of the tanks 482 and 484. The tanks 482 and 484 can be of a suitable form, but are depicted in FIG. 4 as vertical surge tanks each having two fluid compartments. This allows each tank to simultaneously hold different fluids, such as water in one compartment and oil in the other compartment. An oil transfer pump 486 may be operated to pump oil through the system 450 downstream of the separator 470. The separated water from the separator 470 can be similarly routed to a water manifold 490. Like the oil manifold 480, the water manifold 490 includes valves that can be opened or closed to permit water to flow to either of the tanks 482 and 484 or to a water treatment and disposal apparatus 494. A water transfer pump 492 may be used to pump the water through the system.

A well test area may be classified as a hazardous area. In some embodiments, a well test area is classified as a Zone 1 hazardous area according to International Electrotechnical Commission (IEC) standard 60079-10-1:2015.

In the example of FIG. 4, a cabin 496 at a wellsite may include various types of equipment to acquire data from the system 450. These acquired data may be used to monitor and control the system 450. In at least some instances, the cabin 496 can be set apart from the well test area having the system 450 in a non-hazardous area. This is represented by the dashed line 498 in FIG. 4, which generally serves as a demarcation between the hazardous area having the well testing system 450 and the non-hazardous area of the cabin 496.

The equipment of a system can be monitored during a process to verify proper operation and facilitate control of the process. Such monitoring can include taking numerous measurements, examples of which can include choke manifold temperature and pressures (upstream and downstream), heat exchanger temperature and pressure, separator temperature and pressures (static and differential), oil flow rate and volume from the separator, water flow rate and volume from the separator, and fluid levels in tanks of a system.

As an example, a mobile monitoring system may be provided. In such an example, monitoring of a process can be performed on a mobile device (e.g., a mobile device suitable for use in Zone 1 hazardous area, like the well test area). Various types of information may be automatically acquired by sensors and then presented to an operator via the mobile device. The mobile monitoring system may provide various functions, such as a sensor data display, video display, sensor or video information interpretation for quality-assurance and quality-control purposes, and a manual entry screen (e.g., for a digital tally book for recording measurements taken by the operator).

As an example, a site can include one or more computing devices. For example, consider a programmable logic controller (PLC), a gateway device, etc. As to a gateway device or simply gateway, it can include one or more features of an AGORA gateway (e.g., v.202, v.402, etc.) and/or another gateway. For example, consider an INTEL ATOM E3930 or E3950 Dual Core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., 25 cm×20.3 cm×10.1 cm). A gateway may be operatively coupled to various pieces of equipment at a site and operatively coupled to one or more networks, which may include cloud resources (e.g., cloud platform resources). As an example, a gateway may be an edge-type of device that can be controlled, accessed, etc., remotely.

As an example, a system may include one or more components, features, etc., of a SENSIA system (SENSIA LLC, Houston, Texas), such as, for example, the SENSIA AVALON lift surveillance application and associated hardware. For example, such a system may include one or more edge gateways that may be operatively coupled to a surveillance and/or control system. As an example, a system may include one or more features of the QRATE HCC2 controller (SENSIA LLC), which may include a dedicated ARM microcontroller, embedded I/O, serial communications unit(s), Ethernet unit(s), one or more serial ports, one or more GPS units (e.g., consider a GNSS receiver for time synchronization), a video port (e.g., consider an HDMI port for edge application touch interface, etc.), one or more wireless option features, one or more modems (e.g., 5G, 4G LTE, WIFI, etc.), firmware, operating system, etc. As an example, such a controller may provide for running DOCKER containers (Docker, Inc, Palo Alto, California), etc.

As an example, a framework may provide for leveraging latent space understanding of industrial equipment using one or more foundation models (FMs), which may provide for development of an end-to-end framework that may provide for monitoring and/or control of a system or systems. In such an example, monitoring may involve prognostic health monitoring (PHM).

As an example, a model may be developed using one or more of model-based, machine learning-based, and/or hybrid modeling approaches. As an example, deep learning may be utilized. As an example, one or more generative AI types of approaches may be utilized. For example, consider utilization of a generative approach for time series data. As an example, a framework may provide for implementation of a workflow that integrates foundation models with one or more PHM and/or control applications.

A foundation model may be referred to as a large artificial intelligence (AI) model. A foundation model may be a type of machine learning (e.g., deep learning model, etc.) trained on large amounts of data that may include diverse data (e.g., from one or more domains, etc.) such that it can be applied across a wide range of use cases. Various foundation models may be general-purpose technologies that can support a diverse range of use cases. Building foundation models can be highly resource-intensive, particularly for underlying data and compute demands. Various techniques exist that may be utilized for adapting an existing foundation model for implementation as to a specific use case.

Some examples of foundation models include large language models (LLMs) such as, for example, the OpenAI GPT-n series and the GOOGLE BERT model. Foundation models may provide for handling of one or more other modalities, beyond text alone. For example, consider DALL-E and Flamingo for images, MusicGen for music, and RT-2 for robotic control.

As an example, one or more foundation models may be utilized to understand, forecast, and/or analyze time series information. For example, consider a framework that may provide for performing PHM and/or control for assets out-of-the-box with zero or a relatively low number of examples provided to such a foundation model.

As an example, a time series foundation model-based PHM and/or control framework may be implemented for one or more fluid network systems, which may include fluid network systems that may be for production and/or injection, along with production and/or injection facilities. As an example, such a framework may provide for assessing various assets and equipment that may serve various functions, such as, for example, compressors (e.g., pumps, etc.), heat exchangers, floating production, storage, and offloading vessels, etc. In various instances, large, complex machines incur substantial resources (e.g., human, energy, time, etc.) for maintenance and/or replacement, where failure can directly affect efficiency of injection and/or production processes. As an example, a framework may provide for detecting equipment failures, estimating remaining useful life (RUL), providing metrics to assist in planning part replacements and maintenance, control, etc.

As to a time series machine learning-based methods for PHM and/or control, efficacy can depend on aspects of one or more equipment-specific datasets. Various approaches may be challenging to implement in data-scarce scenarios as a machine learning model may be trained specific to a dataset and equipment. In addition, there can be a requirement such that a new model is to be designed for each piece of equipment, which may have substantial training costs associated with modeling.

To address inefficiencies in modeling, a framework may employ a foundation model that is pre-trained on a relatively massive time series synthetic dataset and an available real dataset. While a classical machine learning technique may directly optimize an objective function related to a task, a foundation model may leverage a masked token prediction problem. For example, consider a foundation model in a language domain and/or a vision domain, where a masked token prediction problem can predict a masked portion of time series data and assists the model in learning a distribution of a dataset.

As an example, a method may include pre-training on a large dataset such that a foundation model discerns underlying patterns within data and learns a latent space (e.g., a high dimensional space where input data are encoded semantically, which may be of a lower dimension that an input space). As an example, encoding of input data to a latent space may be referred to as embedding or vector representation. Notably, this embedding of the input data may be directly for multiple downstream tasks such as forecasting, classification, and anomaly detection.

As an example, a latent space may be referred to as a latent feature space or embedding space, which may be an embedding of a set of items within a manifold in which items resembling each other may be positioned closer to one another. As an example, position within a latent space may be viewed as being defined by a set of latent variables that emerge from resemblances from objects.

As an example, dimensionality of a latent space may be engineered to be lower than dimensionality of a feature space from which data are drawn, making the construction of a latent space an example of dimensionality reduction, which may be viewed as a form of data compression. As an example, a latent space may fit via machine learning and may then be used as feature spaces in machine learning models, including classifiers and other supervised predictors. As an example, a latent space may include regions, which may correspond to relevant states, characteristics, classes, behaviors, etc.; noting that transitions in a latent space may be assessed (e.g., consider transitions with respect to time series data windows, etc.). As an example, a workflow may involve data reduction via generation of representations in a latent space where the representations in the latent space, themselves, may be utilized for one or more purposes. As an example, a workflow may involve spatial and/or temporal analysis within a latent space.

As an example, a method may leverage a foundation model to build a relatively generalized (e.g., and universal) PHM and/or control framework that may be employed for multiple PHM and/or control tasks, which may reduce demand for training as to specific examples. Such a framework may be characterized in part by generalizability and scalability of a time series foundation model (TSFM) being utilized for framework generation. As an example, a framework may be extended to incorporate multiple TSFMs, and hence not necessarily restricted to a specific TSFM. Such an approach may enable a paradigm shift in developing, training, and deploying PHM and/or control solutions at scale with zero or a relatively low number of examples (e.g., as may be the case for PHM applications). As an example, a framework may be generated in a manner that has reduced demand for subject matter experts, data scientists, PHM experts, etc.

As to low example number as to prompting, consider one or more of zero-shot prompting where no examples are provided such that a model relies on its pre-trained knowledge; one-shot prompting where a single example is given to clarify a task for a model; and few-shot prompting where two or more examples are included, allowing a model to recognize patterns and deliver more accurate responses.

As to zero shot or few shot learning, it may be generally be defined as a machine learning paradigm where a model is able to recognize and categorize instances of new, unseen classes or tasks without having been explicitly trained on those specific categories. Such an approach may be achieved by leveraging knowledge from one or more other related tasks and using descriptions or attributes to make inferences about one or more new classes.

Zero shot or few shot prompting may be considered to be an application of zero shot or few shot learning, noting differences in scope and technique. For example, zero shot learning can be a machine learning paradigm that enables a model to recognize concepts it has never seen, while zero-shot prompting can be a technique for eliciting a response from a pre-trained large language model (LLM) without providing examples. As explained, in zero shot prompting, a model may be prompted to generate a response without receiving an example of the desired output for a use case where zero shot prompting is an application of zero shot learning, which can be a machine learning pattern that asks models to make predictions with zero training data. As an example, a few-shot approach may utilize fewer than 15 examples or samples, which may be within the realm of human input and/or human labeling in a relatively short period of time.

As an example of a zero shot technology, consider a You Only Look Once (YOLO) model, which may recognize objects from categories the YOLO model has never encountered during its training phase. Prompting is a technique to interact with such a model, for example, allowing a user (human or machine) to specify what object or objects to detect using text descriptions. A YOLO model may be multimodal in that it may implement a technique like contrastive language-image pre-training (CLIP) to convert text prompts into a format that can be understood by the model's visual components. As to inference, when a prompt is received, a zero shot model can use its pre-trained knowledge to find one or more objects in an image or video that correspond to the prompt's description, even if the specific object or objects may not have been in the original training dataset.

As to CLIP models, consider one or more available from OpenAI that can provide for connecting images and text by training on a large dataset of text-image pairs from the Internet. In a CLIP approach, model components work together to learn the relationship between natural language descriptions and the images they refer to, without a demand for specific labeled data. CLIP model components can include: an image encoder (e.g., a vision model that takes an image as input and produces a high-dimensional vector representation, or embedding); an architecture (e.g., a convolutional neural network (CNN) such as a ResNet or a Vision Transformer (ViT)), a text encoder (e.g., a language model that may be based on a transformer architecture, that takes a text input (like a caption or sentence) and produces a multidimensional vector representation); an architecture (e.g., consider a 12-layer transformer to process text tokens, etc.); a shared embedding space (e.g., where image and text encoders are trained to project their respective outputs into a common, shared vector space) where the space allows the model to measure the similarity between an image and a text description, for example, by computing the dot product of their embeddings; and contrastive pre-training, for example, where a training objective can teach CLIP to align images and text in the shared embedding space. As an example, a CLIP model can be trained to pull embeddings of matching pairs closer together while pushing the embeddings of incorrect, non-matching pairs apart. As an example, one or more techniques, features, components, etc., implemented for a CLIP approach may be utilized for a TSFM approach.

As an example, a framework may provide for receiving time series data and one or more other types of data to operate in a multimodal manner. For example, a framework may provide for handling time series data and one or more other types of data, such as, for example, textual information, physics equations, metadata, audio signals, images, etc. Such information may be provided by one or more domain experts and/or through data and may be incorporated as additional input to one or more TSFMs and/or in one or more model loss functions.

As an example, consider a production scenario where a production facility includes assets and/or equipment for production, separation, treatment, and processing of oil and gas at a production site. These assets may be continuously in an operating mode and therefore an unplanned downtime or sudden equipment failure could lead to oil and gas wastage, costing billions of dollars each year (e.g., as to loss of production, equipment costs, human labor, time, emissions, etc.).

As explained, a framework may leverage one or more foundation models even where some amount of data scarcity may exist. As explained, a relatively universal foundation model may be utilized that is pre-trained on a relatively massive time series synthetic dataset and an available real dataset. As explained, while classical machine learning method directly optimizes an objective function related to a task, a foundation model leverages a masked token prediction problem. As an example, a masked token prediction problem-solution approach may be implemented to predict a masked portion of time series data, which may assist a model to learn the distribution of one or more datasets (e.g., synthetic and real). By pre-training on a large dataset (e.g., which may include synthetic data and/or real data), a foundation model may discern underlying patterns within data and learns a latent space where input data are encoded semantically. Such embedding of the input data may be directly for multiple downstream tasks such as forecasting, classification, and anomaly detection. As explained, a foundation model may be leveraged for multiple tasks, which can reduce demands to train a new model on each dataset for equipment monitoring and analysis.

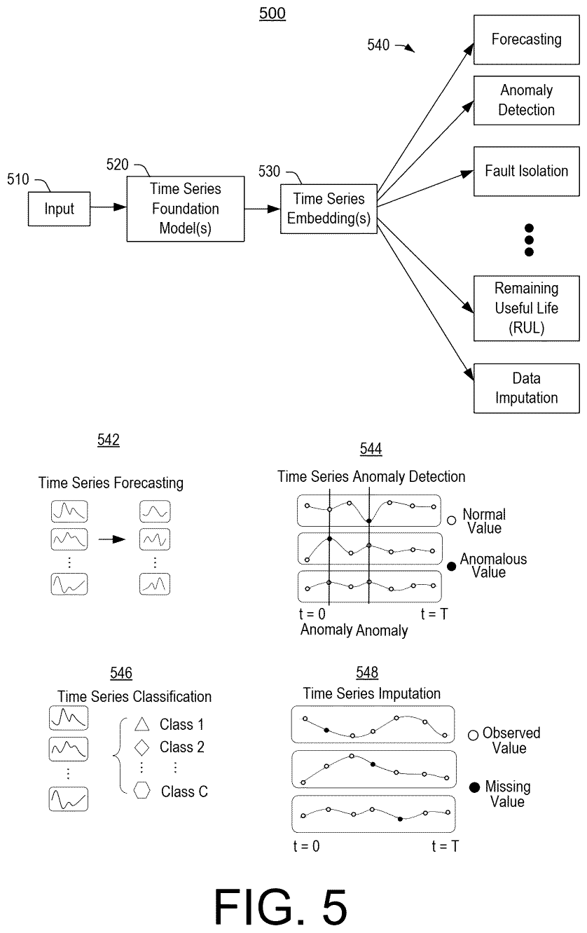

FIG. 5 shows an example of a time series foundation model (TSFM) workflow 500 for PHM and/or control analysis. As shown, the workflow 500 can include an input block 510, a one or more TSFMs block 520, a time series embedding(s) block 530, and a number of output blocks 540 (e.g., forecasting, anomaly detection, fault isolation, remaining useful life (RUL), data imputation, etc.). As shown, one or more TSFMs of the block 520 may be leveraged to generate representations in a latent space, as indicated by the time series embedding(s) block 530. Such representations may be assessed for indicators as to forecasting, anomaly detection, fault isolation, RUL, data imputation, control, etc.

In the example of FIG. 5, various examples of tasks are shown, including time series forecasting 542, time series anomaly detection 544, time series classification 546, and time series imputation 548. These examples are illustrated as may be graphics of a graphical user interface (GUI) with respect to time series data without illustrating embeddings in a latent space, which may or may not be readily viewable or discernable to the human eye. As an example, a latent space with one or more embeddings may be subject to one or more techniques that may provide for visualization. For example, consider a technique such as principal component analysis (PCA) or other dimensional reduction technique and/or one or more animation techniques that may show changes in space, shapes, etc. As an example, a PCA approach may be applied on a subset of embeddings, etc., which may be for a time or time window, etc. As an example, analyses within a latent space may provide for discerning one or more issues, control opportunities, etc., with respect to field equipment, field operations, etc.

As an example, different time series tasks may be used for PHM and/or control analysis. For example, for a given type of equipment, multiple measurements from sensors may be acquired where such measurements help to determine a state of a system at any given point in time. As an example, a modeling approach may consider univariate (e.g., measurement from one sensor) and multivariate (e.g., measurements from multiple sensors at a time) approaches and may also include static and dynamic known covariates (e.g., exogenous variables). As to known covariates, such values may always be known to at all times where a workflow may include conditioning a modeling approach on input and known covariates, which may help to accurately solve tasks.

Forecasting is a classical time series problem that aims to determine the future state based on the current input and past state of the system. In a PHM and/or control analysis, a workflow may include modeling the state of equipment as a function of multiple sensor measurements and time. Such an approach may apply to short-term forecasting and long-term forecasting, where, for example, the short-term forecasting may indicate failure in a near future time frame; whereas the long-term forecasting may be utilized to estimate the life-cycle of a type of equipment. In either instance, control may be implemented to thereby control field equipment as to one or more processes, which may help to mitigate one or more types of risk.

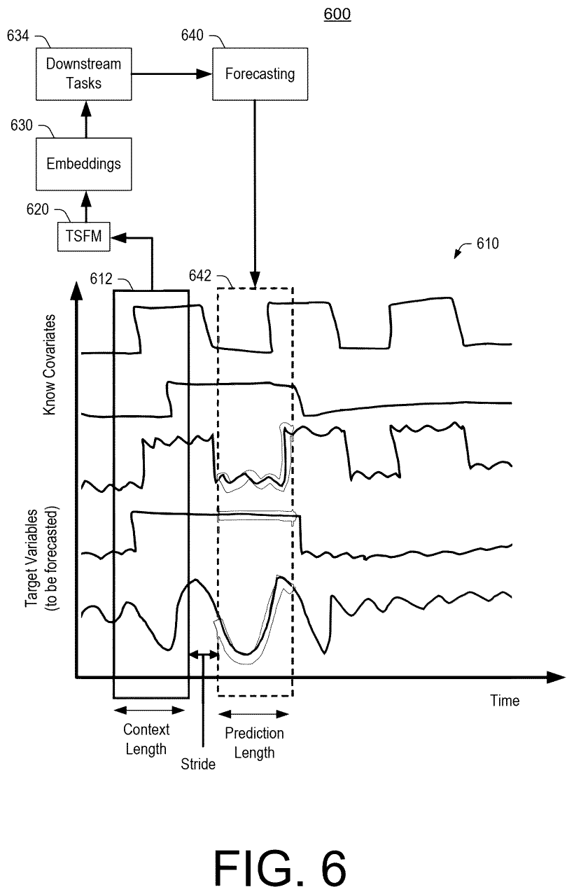

FIG. 6 shows an example of a graphical user interface (GUI) 600 that illustrates data and techniques with respect to time. For example, the GUI 600 may illustrate features of an example of a workflow for time series forecasting using one or more TSFMs. As shown, target variables are to be forecast, which may be determined for a context length for historical time, and combined with known covariates (or exogenous variables). Such information may be input to a TSFM to generate embeddings (e.g., representations in a latent space), which may provide for one or more downstream tasks. As shown, in the example of FIG. 6, forecasting based at least in part on the embeddings may provide for outputting values for the target variables, for example, for a future time or span of time, as indicated by a prediction length (e.g., a time span). In such an approach, values of one or more target variables may be predicted using a TSFM approach that generates embeddings (e.g., in a latent space, etc.).

In the example of FIG. 6, the GUI 600 can provide for rendering of one or more graphics 610 of data with respect to time where a context length 612 may be identified for input to a TSFM 620 to generate embeddings 630 for one or more downstream tasks 634 which may provide for forecasting 640. For example, consider a forecast being generated for a prediction length 642 that can be rendered to the GUI 600 along with the graphics 610 of data with respect to time. In such an example, a stride or stride length may be an amount of time that separates the context length 612 from the prediction length 642. As an example, one or more of the lengths may be adjustable. As an example, a length may be adjustable automatically, for example, responsive to an event. As an example, an event may have an associated time characteristic that can be utilized to set one or more lengths. In such an example, a framework that implements one or more TSFMs may be dynamically adjustable to improve performance, output, control, etc.

As an example, a framework may provide for one or more types of autoregression. For example, consider extending a forecasting task to iteratively predict sensor measurements by moving a context window towards right by prediction length amount (see, e.g., FIG. 6). In such an example, when moving the context window from left to right (e.g., forward in time), it is possible to incorporate a newly predicted forecast as input and then forecast a next prediction horizon. Such an approach can be repeated to obtain a future forecast of sensor measurements to a desired time point.

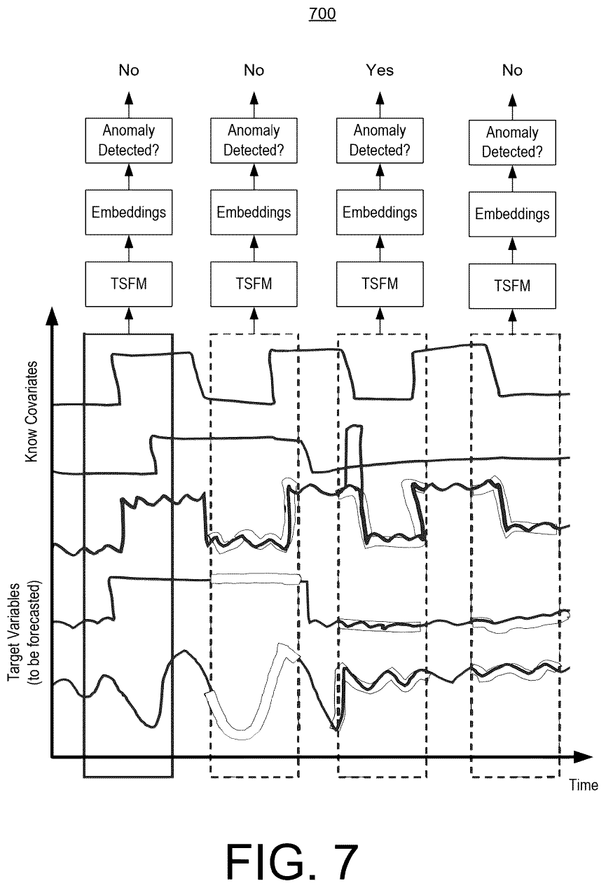

FIG. 7 shows an example of a graphical user interface (GUI) 700 that illustrates data and techniques with respect to time. For example, the GUI 700 may illustrate features of an example of a workflow for time series forecasting using one or more TSFMs for purposes of anomaly detection.

As to anomaly detection, consider comparing an embedding of observed and forecasted measurements at a time point using a desired similarity metric (or metrics). In general, an assumption may be made that anomalies tend to be rare abnormal patterns and not amenable to being forecasted based on nominal input data and model hidden state. Therefore, a foundation model may forecast future values based on historic patterns and an anomalous pattern may be detected based on dissimilarity between embedding of predicted and observed measurements. To measure the dissimilarity, a framework may employ one or more techniques, such as, for example, one or more of cosine similarity of embeddings, distance-based metrics with certain thresholds, unsupervised clustering in the embedding space after dimensionality reduction, an autoencoder approach to learn the distribution of the embeddings to name just a few examples. As an example, to be able to detect anomalies in a better manner, a TSFM fine-tuned on nominal equipment operation may be employed.

As shown in the example of FIG. 7, three time windows do not indicate anomalies (“No”) while one time window does (“Yes”). In the time window that indicates an anomaly, as can be discerned visually, there is a deviation from an expected step type of shape with a square shaped upward spike.

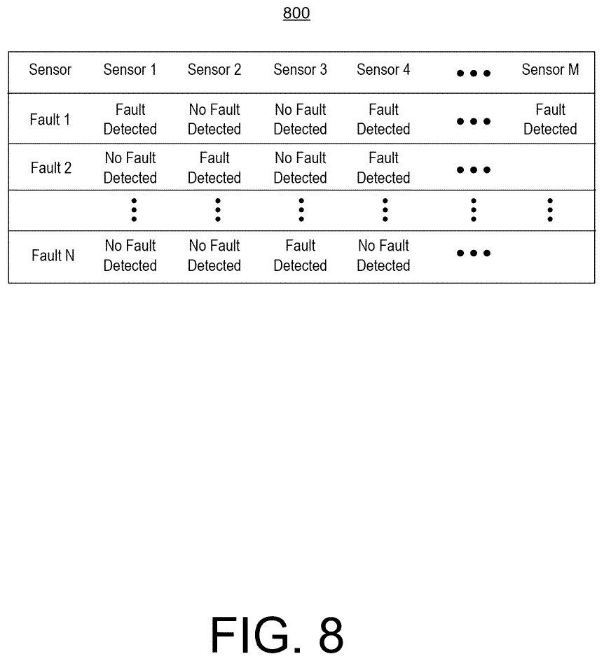

FIG. 8 shows an example of a graphical user interface (GUI) 800 that illustrates an example of a data structure. For example, the GUI 800 may illustrate various sensors and associated measurements with respect to an issue such as a fault or faults. Such an approach may build on anomaly detection, for example, by further investigating an anomaly to understand the reason behind it using a Diagnosis matrix (D-matrix). As an asset usually includes multiple auxiliary sub-components and a malfunction in one or more of these sub-components could lead to the asset's ill-performance, a framework may compute an embedding of predicted and observed values of each sensor individually. Similar to anomaly detection, a framework may compare the embedding to identify the sensor causing the anomaly, and compute the D-matrix, which may help to isolate a sub-component causing the anomaly.

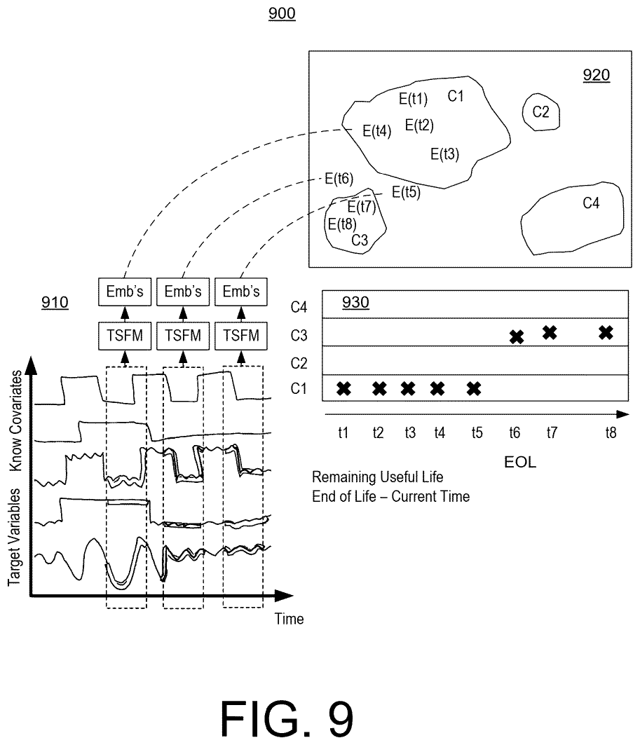

FIG. 9 shows an example of a graphical user interface (GUI) 900 that illustrates data and techniques with respect to time. For example, the GUI 900 may illustrate features of an example of a workflow for time series forecasting using one or more TSFMs for purposes of RUL determination. In the example GUI 900, graphics for data 910 are shown with respect to time and individual time windows for which embeddings can be generated and represented in a space 920, which may include one or more classes, characteristics, etc. For example, consider regions within the space 920 that can include C1, C2, C3, and C4 where embeddings may be within a region or outside of a region. As shown, a chart 930 can be rendered as part of the GUI 900 where regions in the space 920 for embeddings may be represented with respect to time intervals (e.g., time windows, etc.). As shown, at time t6, a change or transition is indicated from C1 to C3, which may indicate an end-of-life (EOL), where remaining useful life (RUL) may be determined as EOL minus a current time. In the example of FIG. 9, the regions C2 and C4 of the space 920 do not have any indicators for the time series from t1 to t8; whereas, the embedding E (t5) is close to region C1 and the embedding E (t6) is close to region C3, which may provide for indications of a transition to a physical system as represented by various data (e.g., sensor data, control data, operational data, etc.). Further, all of E (t1), E (t2), E (t3), and E (t4) are within the region C1 while E (t7) and E (t8) are within the region C3. Hence, embeddings before and after the transition period are consistent with a transition and may be utilized in performing one or more analyses.

For example, a framework may provide for estimating the remaining useful life of one or more types and/or instances of equipment. As an example, a framework may adopt an assumption such as equipment degradation is a slow process and, therefore the inherent state of an equipment would gradually change from a nominal state to a faulty state. In such an example, the gradual change may be captured using one or more techniques. For example, consider using a large separation between the embeddings in the latent space, and/or using the future prediction of different sensors that may increase or decrease with respect to one or more thresholds. As an example, a threshold value or threshold values for different sensors may be calibrated using domain knowledge and/or historical observations. As an example, an estimated RUL at any given point may be computed by a difference between a future time when an asset assumed a faulty state and the present time, which may be termed end-of-life (EOL or EoL).

As an example, a framework may provide for handling one or more types of tasks, which may include, for example, one or more of identifying faults, detecting anomalies, data imputations, etc., for one or more types of domains, such as, for example, production, injection, fracturing, stimulation, drilling, well construction, etc. Such applications may be based on demands of fine tuning or performing zero-shot inference on a model on their datasets, where a framework or frameworks may be deployed at a facility and/or elsewhere, for example, in a manner that can offer real time predictions. As an example, one or more models may be fine-tuned to run for individual equipment and/or for various equipment based on a desired outcome, task, etc., where, for example, a user may be able to select a model to run from a pool of models. In such an example, a GUI may be rendered that may provide for review of models where one or more graphic controls may be actuated to select one or more of the models. Such an approach provides a custom setup and flexibility to deploy and use applications. In various instances, one or more models may be implemented without demand for cloud compute or other remote server access, which may help to reduce bottlenecks for various field implemented scenarios. As an example, a framework may be implemented in the field using field compute resources, as may be available in a controller, an edge device, edge devices, etc. As an example, one or more relatively lightweight model framework may be utilized.

As explained data scarcity can exist for one or more types of equipment as to one or more types of operations, behaviors, etc. Such scarcity can make modeling challenging, particularly as to PHM based on modeling equipment behavior and fault progression. As explained, a TSFM approach may provide for generation of a framework that can be relatively universal, generalizable and scalable. Such an approach may be implemented where data are available, whether synthetic and/or actual, and where data may be relatively scarce, as may be the case for anomalies and/or other behaviors.

As explained, a framework may provide for generation of representations in a latent space. In such an example, as the framework may be dependent on latent space representation, it may be relatively decoupled from a particular TSFM. As an example, a selected TSFM may have a scalable and generalizable deep understanding of a system out-of-the-box from the get-go. Such a TSFM may be leveraged for building a generalizable and scalable PHM and/or control framework. As explained, a universal and generalizable solution may not demand unique machine learning for each task. As an example, a framework may be adaptable, for example, adaptable to one or more new and/or improved TSFMs. For example, as the state of the art of TSFMs improves, accuracy and performance of a framework may improve.

As explained, a workflow may leverage one or more TSFMs for developing an end-to-end PHM and/or control framework for assets (e.g., injection and/or production systems equipment, such as compressors and heat exchangers, etc.).

Referring to the example network 240 of FIG. 2, one or more of the wells and/or other equipment (e.g., manifolds, etc.) may be instrumented with one or more multi-phase flow meters (MPFMs). As an example, a system can include one or more multiphase flow meters (MPFMs), which may be installed permanently and/or on an as-desired basis. As an example, an MPFM can include one or more features of the Vx SPECTRA surface multiphase flow meter (SLB, Houston, Texas). Such a flow meter can utilize a spectrum analysis to accurately measure oil, gas, and water flow rates without phase separation. Such a single flow meter may be transported from location to location to acquire various MPFM measurements.

The Vx SPECTRA flow meter includes a venturi section and a multivariable transmitter and associated circuitry for measuring differential pressure, pressure and temperature to measure total flow rate; a nuclear source and detector that obtain oil, gas, and water holdups; and a compact flow computer that performs computations and converts flow measurements from line to standard conditions. The Vx SPECTRA flow meter uses full-gamma spectroscopy to accurately capture multiphase flow dynamics for real-time monitoring and analysis.

The Vx SPECTRA flow meter can include an embedded computer running a real time operating system that can handle data from instrumentation of the flow meter. The embedded computer can run an interpretation model and handle external communications. The embedded computer can provide for adjusting one or more parameters that may be calibration parameters.

A flow meter can include a radioactive source such as, for example, a 133Ba radioactive source. Such a flow meter can include pressure barriers made of extremely hard ceramic to support line pressure but also transparent to the 133Ba radiation path across the Venturi throat. A source capsule can be installed in a source holder, shielded with tungsten, which can be an external source shielding made of tungsten where a stainless steel source holder contains a small capsule of 133Ba.

An MPFM can include various components, which may be physical hardware components such as pressure, differential pressure and temperature sensors, associated multi-variable transmitter components, radioactive source and detector components, flow computer components, etc. As an example, an MPFM can include one or more models, which may include model parameters. As an example, one or more types of parameters (e.g., physical, electrical, firmware, software, etc.) may be adjustable for purposes of calibration of an MPFM.

As an example, a field can include multiple sites where multiple, for example more than 60 MPFMs are installed. Operators can obtain continuous and reliable flow rates from a plurality of MPFMs permanently installed on wells or manifolds (connected to multiple wells). MPFMs may require recalibration with marked change in operational parameters and composition (e.g. water salinity) of production fluids. As an example, an operator can be provided with a pre-defined calibration program with a fixed frequency of calibration operations for each MPFM (e.g., 2 to 4 months). In some cases, changes in fluid properties (e.g., in salinity) may be so rapid during a flow back production period, such that an untimely calibration to adjust for changes in salinity may result in a large measurement error in water cut, and in individual phase flow rates.

A method that can help to optimize a calibration schedule may result in an operational cost reduction of 20 percent or more, by minimizing the number of manual water sampling and calibration interventions at an MPFM site. Further, such a method can improve data quality, decision making and control, reduce unnecessary carbon emissions, and HSE risk. While MPFMs are mentioned, consider one or more other types of field equipment, field operations, etc. For example, consider a burner or flaring equipment, which may provide for indications of emissions, flare quality, a flare being lit or not, etc. In such an example, an anomaly may be detected as to one or more aspects of a field system where one or more control actions may be taken to address the anomaly or risk of the anomaly occurring. As an example, a relationship may exist between flow and emissions, which may be assessed or controlled with respect to one or more flow meters, one or more flow controllers, one or more burners, etc.

As an example, a framework may provide for assessing performance, behavior, etc., of one or more flow meters. For example, consider anomaly detection, fault isolation, RUL, end-of-life (EoL), etc. In such an example, one or more actions may be taken as to field operations, which may include estimating flow using one or more other approaches, adjusting flow based on uncertainty due to a flow meter concern, etc.

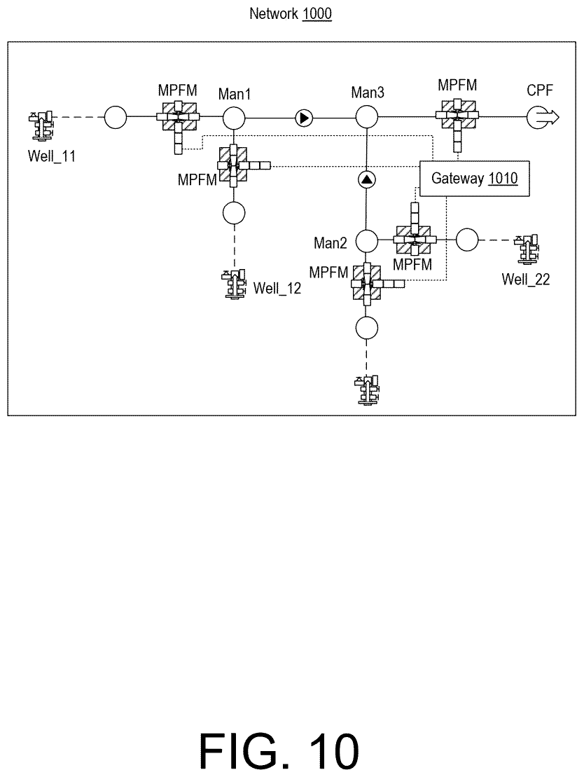

FIG. 10 shows an example of a surface production network 1000 that includes various wells and one or more sensors (e.g., MPFMs, etc.) that may be operatively coupled to a gateway 1010. As an example, the gateway 1010 may include one or more features of an AGORA gateway (e.g., v.202, v.402, etc.) and/or another gateway, such as, for example, a SENSIA system, etc. As an example, a framework or a portion thereof may be operable using a gateway. While the network 1000 shows one or more sensors, one or more other types of equipment may be present and monitored and/or controlled via a framework, which, for example, may be at least in part implemented via the gateway 1010.

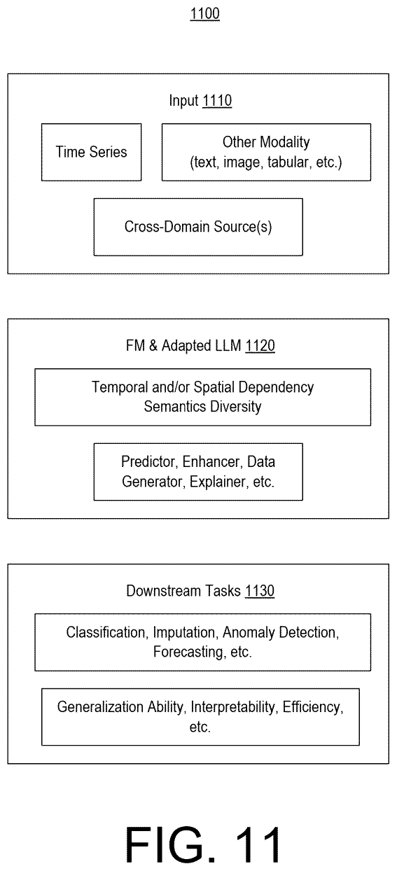

FIG. 11 shows an example of a system 1100 that includes a number of functional blocks 1110, 1120, and 1130, which pertain to foundation models, as may be employed across various tasks and domains in the context of time series analysis. As shown, two classes can include foundation models pre-trained from scratch for time series and adapted large language foundation models (e.g., LLM) for time series. As an example, a method may include integrating time series properties and/or fusing multi-modality data. An article by Ye et al., entitled “A Survey of Time Series Foundation Models: Generalizing Time Series Representation with Large Language Model”, 7 May 2024 (arxiv.org/abs/2405.02358), is incorporated by reference herein in its entirety.

In the example of FIG. 11, the block 1110 is an input block for one or more modalities, which can include time series and one or more other modalities (e.g., text, image, tabular, etc.); the block 1120 is a foundation model and adapted LLM block for temporal and/or spatial dependency and/or semantics diversity, where the block 1120 may provide a predictor, an enhancer, a data generator, an explainer, etc.; and the block 1130 is a downstream tasks block for one or more types of tasks, which may include one or more of classification, imputation, anomaly detection, forecasting, etc. As an example, the block 1130 may provide for generalization ability, interpretability, efficiency, etc. As explained, a framework may provide for generation of control instructions for controlling field equipment, which may be based at least in part on one or more machine learning model outputs (e.g., responsive to sensor data, etc.).

As an example, a system, a method, etc., can utilize one or more types of ML models (e.g., predictive, etc.). As to examples of some types of ML models, consider one or more of a support vector machine (SVM) model, a k-nearest neighbors (KNN) model, an ensemble classifier model, a neural network (NN) model, etc. As an example, an ML model can be a deep learning model (e.g., deep Boltzmann machine, deep belief network, convolutional neural network, stacked autoencoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, encoder, autoencoder, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, an ML model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train an ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) (e.g., Lite Runtime or LiteRT or LRT) or another type of lightweight framework. LiteRT, formerly known as TensorFlow Lite, is a high-performance runtime for on-device AI that allows for use of ready-to-run LiteRT models and/or other models, for example, for a range of ML/AI tasks; noting that models may be converted (e.g., consider TensorFlow, PyTorch, JAX, etc., models) to the TFLite format using the AI Edge conversion and optimization tools. TFL or LRT is a set of tools that enables on-device machine learning where models may run on mobile, embedded, and IoT devices. LRT is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). LRT offers multiple platform support, covering ANDROID and iOS devices, embedded LINUX, and microcontrollers. LRT offers diverse language support, which includes JAVA, SWIFT, Objective-C, C++, and PYTHON. LRT offers high performance, with hardware acceleration and model optimization.

As an example, a gateway such as, for example, the gateway 1010 of FIG. 10, may be utilized to implement a framework. As an example, a gateway may be configured to include a framework. As an example, a gateway may include multiple frameworks where, for example, a framework may be or include an ML framework (e.g., consider the TFL framework).

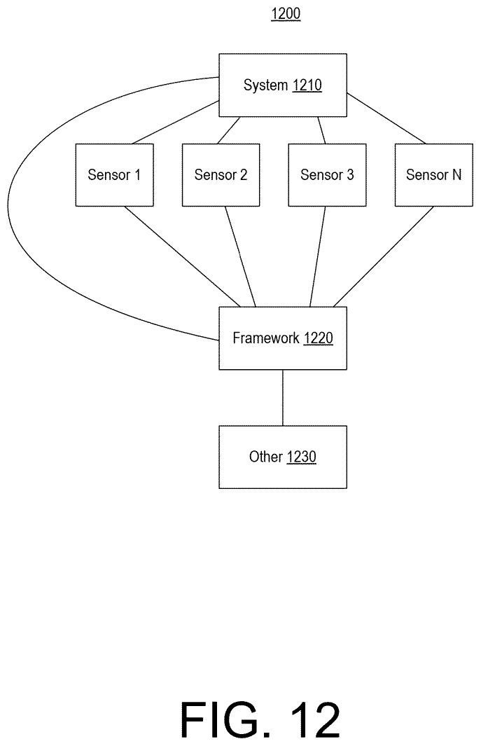

FIG. 12 shows an example of a system 1200 that includes a field system 1210 with one or more sensors and a framework 1220, which may be operatively coupled to the field system 1210 and may be operatively coupled to one or more other systems 1230.

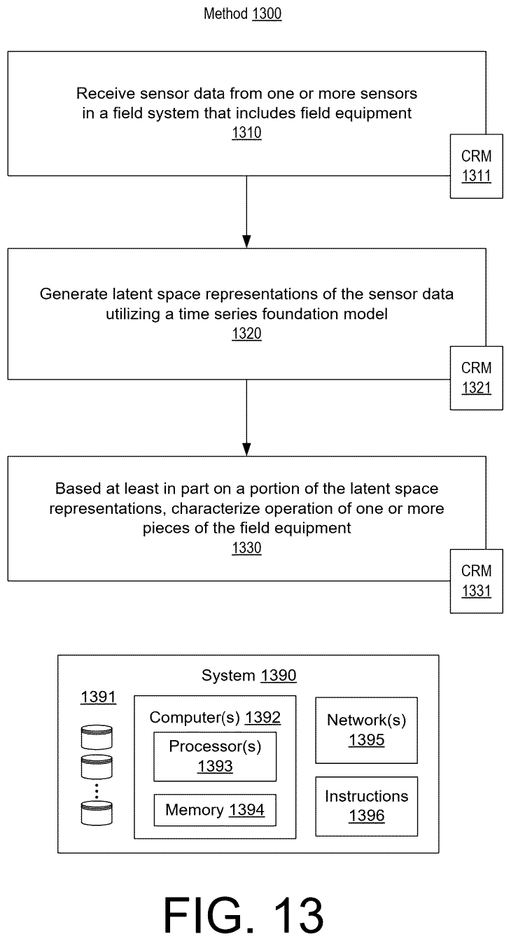

FIG. 13 shows an example of a method 1300 and an example of a system 1390. As shown, the method 1300 can a reception block 1310 for receiving sensor data from one or more sensors in a field system that includes field equipment; a generation block 1320 for generating latent space representations of the sensor data utilizing a time series foundation model; and a characterization block 1330 for, based at least in part on a portion of the latent space representations, characterizing operation of one or more pieces of the field equipment.

In the example of FIG. 13, the system 1390 includes one or more information storage devices 1391, one or more computers 1392, one or more networks 1395 and instructions 1396. As to the one or more computers 1392, each computer may include one or more processors (e.g., or processing cores) 1393 and memory 1394 for storing the instructions 1396, for example, executable by at least one of the one or more processors. As an example, a computer may include one or more network interfaces (e.g., wired or wireless), one or more graphics cards, a display interface (e.g., wired or wireless), etc.

The method 1300 is shown along with various computer-readable media blocks 1311, 1321 and 1331 (e.g., CRM blocks). Such blocks may be utilized to perform one or more actions of the method 1300. For example, consider the system 1390 of FIG. 13 and the instructions 1396, which may include instructions of one or more of the CRM blocks 1311, 1321 and 1331.

As an example, a method can include receiving sensor data from one or more sensors in a field system that includes field equipment; generating latent space representations of the sensor data utilizing a time series foundation model; and, based at least in part on a portion of the latent space representations, characterizing operation of one or more pieces of the field equipment. In such an example, generating may include utilizing one or more known covariates (e.g., exogenous variables).

As an example, characterizing may include one or more of data imputation, forecasting, anomaly detection, fault isolation, determining remaining useful life, and determining end-of-life.

As an example, sensor data may be time series data. Such data may be acquired according to one or more data rates (e.g., frequencies, etc.). As an example, a method may include data processing such that data are in a particular form for receipt by one or more TSFMs.

As an example, field equipment may include a pump, a heat exchanger, a separator, a sensor, etc. As an example, a sensor may be a flow meter.

As an example, a method may include, based at least in part on characterizing, controlling field equipment. In such an example, controlling may reduce risk of failure of at least one of the one or more pieces of field equipment.

As an example, a field system may include a fluid network and/or a rig or rigs (e.g., one or more rigs suitable for drilling, completions, logging, etc.).

As an example, a system can include a processor; a memory accessible to the processor; processor-executable instructions stored in the memory and executable by the processor to instruct the system to: receive sensor data from one or more sensors in a field system that includes field equipment; generate latent space representations of the sensor data utilizing a time series foundation model; and, based at least in part on a portion of the latent space representations, characterize operation of one or more pieces of the field equipment.

As an example, one or more computer-readable media may include computer-executable instructions executable by a system to instruct the system to: receive sensor data from one or more sensors in a field system that includes field equipment; generate latent space representations of the sensor data utilizing a time series foundation model; and, based at least in part on a portion of the latent space representations, characterize operation of one or more pieces of the field equipment.

As an example, a computer program product can include one or more computer-readable storage media that can include processor-executable instructions to instruct a computing system to perform one or more methods and/or one or more portions of a method.

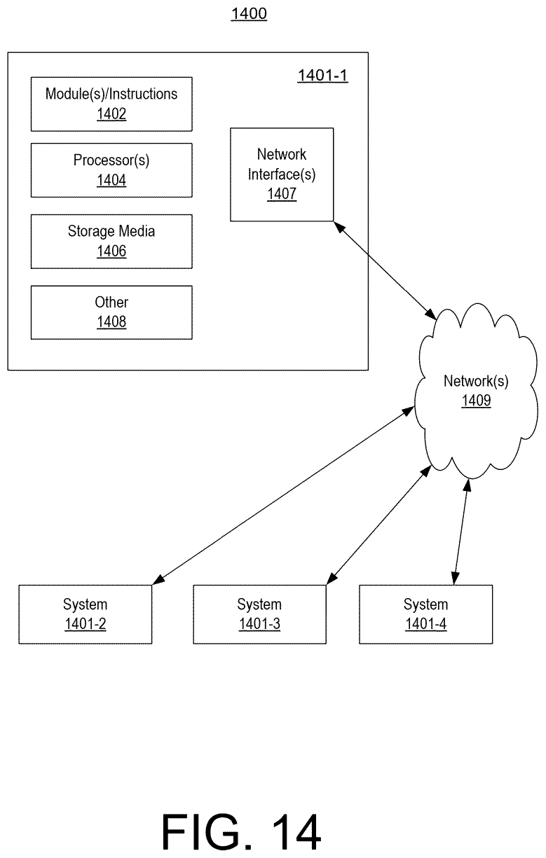

In some embodiments, a method or methods may be executed by a computing system. FIG. 14 shows an example of a system 1400 that can include one or more computing systems 1401-1, 1401-2, 1401-3 and 1401-4, which may be operatively coupled via one or more networks 1409, which may include wired and/or wireless networks. As shown, one or more other components 1408 may be included in the system 1400.

As an example, a system can include an individual computer system or an arrangement of distributed computer systems. In the example of FIG. 14, the computer system 1401-1 can include one or more modules 1402, which may be or include processor-executable instructions, for example, executable to perform various tasks (e.g., receiving information, requesting information, processing information, simulation, outputting information, etc.).

As an example, a module may be executed independently, or in coordination with, one or more processors 1404, which is (or are) operatively coupled to one or more storage media 1406 (e.g., via wire, wirelessly, etc.). As an example, one or more of the one or more processors 1404 can be operatively coupled to at least one of one or more network interface 1407. In such an example, the computer system 1401-1 can transmit and/or receive information, for example, via the one or more networks 1409 (e.g., consider one or more of the Internet, a private network, a cellular network, a satellite network, etc.).

As an example, the computer system 1401-1 may receive from and/or transmit information to one or more other devices, which may be or include, for example, one or more of the computer systems 1401-2, etc. A device may be located in a physical location that differs from that of the computer system 1401-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1406 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving sensor data from one or more sensors in a field system that comprises field equipment;
generating latent space representations of the sensor data utilizing a time series foundation model; and
based at least in part on a portion of the latent space representations, characterizing operation of one or more pieces of the field equipment.

2. The method of claim 1, wherein the generating comprises utilizing one or more known covariates.

3. The method of claim 1, wherein the characterizing comprises data imputation.

4. The method of claim 1, wherein the characterizing comprises forecasting.

5. The method of claim 1, wherein the characterizing comprises anomaly detection.

6. The method of claim 1, wherein the characterizing comprises fault isolation.

7. The method of claim 1, wherein the characterizing comprises determining remaining useful life.

8. The method of claim 1, wherein the characterizing comprises determining end-of-life.

9. The method of claim 1, wherein the sensor data are time series data.

10. The method of claim 1, wherein the field equipment comprises a pump.

11. The method of claim 1, wherein the field equipment comprises a heat exchanger.

12. The method of claim 1, wherein the field equipment comprises a separator.

13. The method of claim 1, wherein the field equipment comprises one of the one or more sensors.

14. The method of claim 1, wherein the field equipment comprises a flow meter.

15. The method of claim 1, comprising, based at least in part on the characterizing, controlling the field equipment.

16. The method of claim 15, wherein the controlling reduces risk of failure of at least one of the one or more pieces of field equipment.

17. The method of claim 1, wherein the field system comprises a fluid network.

18. The method of claim 1, wherein the field system comprises a rig.

19. A system comprising:
a processor;
a memory accessible to the processor;
processor-executable instructions stored in the memory and executable by the processor to instruct the system to:
receive sensor data from one or more sensors in a field system that comprises field equipment;
generate latent space representations of the sensor data utilizing a time series foundation model; and
based at least in part on a portion of the latent space representations, characterize operation of one or more pieces of the field equipment.

20. One or more computer-readable media comprising computer-executable instructions executable by a system to instruct the system to:
receive sensor data from one or more sensors in a field system that comprises field equipment;
generate latent space representations of the sensor data utilizing a time series foundation model; and
based at least in part on a portion of the latent space representations, characterize operation of one or more pieces of the field equipment.
